(19) United States
(12) Patent Application Publication
(10) Pub. No.: US 2007/0283830 A1
(43) Pub. Date: Dec. 13, 2007

(54) Method for controlling an inking unit of a printing press

(75) Inventor: Nikolaus Pfeiffer, Heidelberg (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/799,292

(22) Filed: May 1, 2007

(30) Foreign Application Priority Data
May 15, 2006 (DE) 10 2006 022 520.1

(51) Int. Cl. B41F 1/40

(52) U.S. Cl. 101/484

(57) ABSTRACT

A method for controlling an inking unit of a printing press, in particular a sheet-processing offset printing press, having at least one ink metering element and a control unit, includes changing over the ink metering element from a first ink amount metering to a second ink amount metering for a desired inking to be achieved, and setting the ink metering element with the control unit to a temporary third ink amount metering at least for a time period during a non-steady-state phase of the inking unit before the desired inking is achieved. The control unit processes at least one value of a current actual inking which is, in particular, a corrected value of a measured non-steady-state actual inking, during the non-steady-state phase of the inking unit for determining the temporary third ink amount metering.

### CROSS-REFERENCE TO RELATED APPLICATION

This application claims the priority, under 35 U.S.C. §119, of German Patent Application DE 10 2006 022 520.1, filed on May 15, 2006; the prior application is herewith incorporated by reference in its entirety.

### BACKGROUND OF THE INVENTION

### Field of the Invention

The invention relates to a method for controlling an inking unit of a printing press having at least one ink metering element and a control unit. The ink metering element is changed over from a first ink amount metering to a second ink amount metering for a desired inking which is to be achieved. The ink metering element is set by the control unit to a temporary third ink amount metering at least for a time period during a non-steady-state phase of the inking unit before the desired inking is achieved.

As parts of printing units of printing presses, in particular planographic printing presses or offset printing presses, inking units have a certain reaction time when they are transferred or changed over from a first steady state, in which a first inking of a printing material is achieved, into a second steady state, in which a second inking of a printing material is achieved. In other words, proceeding from an old steady state, a new steady state cannot be achieved instantaneously, but only after a certain transient time interval or a non-steady-state phase of the inking unit. In order to accelerate the inking unit reaction, that is to say in order to shorten the reaction time, it is known to perform an increased adjustment of the ink metering element or elements of the inking unit for a brief period, in particular during the non-steady-state phase. As a result, a different ink amount than in the first and in the second state is introduced into the inking unit temporarily. In that case, the increased adjustment considerably exceeds or considerably undershoots the required ink amount supply in the second steady state, depending on the goal which is to be achieved. In that way, in order to achieve a second steady state with greater ink application, an additional ink amount is introduced into the inking unit or, in order to achieve a second steady state with reduced ink application, an excess ink amount leaves the inking unit due to reduced supply.

For example, German Published, Non-Prosecuted Patent Application DE 100 56 247 A1, corresponding to U.S. Pat. No. 6,546,870, has disclosed a method for controlling the ink amount in a zonal inking unit of a printing press. Correction ink amount flows are introduced for each of the inking zones during the transition time interval if the setpoint value of the ink amount to be emitted for the inking zone is changed from a first value to a second value. Due to the distribution of the ink amount which is introduced into the inking unit, the ink amounts in the individual inking zones are not independent of one another. Further correction ink amount flows are therefore provided which compensate for the lateral ink flow between adjacent inking zones in the transition time interval.

Furthermore, German Published, Non-Prosecuted Patent Application DE 101 09 198 A1, corresponding to U.S. Pat. No. 6,536,341, has disclosed a printing ink regulating apparatus. A reference correction value for the change in the degree of the opening of the printing ink supply is determined in accordance with the density difference between the desired density of the inking of a printed object or a reference density and the measured density. The degree of the opening is changed during a predefined number by a correction value which results from multiplication of the reference correction value with a coefficient which is greater than 1. In that way, the degree of opening is greater during a transition time interval than the degree of opening which is adapted to the desired density if the desired density is greater than the measured density, and is smaller than the degree of opening which is adapted to the desired density if the desired density is smaller than the measured density.

In many parameter combinations which occur in practice, in particular if the first state is not sufficiently steady-state, the above-described procedure cannot lead to the desired result. In unfavorable situations, an extended reaction time of the inking unit with respect to a changeover can even occur.

### SUMMARY OF THE INVENTION

It is accordingly an object of the invention to provide a method for controlling an inking unit of a printing press, which overcomes the hereinafore-mentioned disadvantages of the heretofore-known methods of this general type, with the result that the inking unit reaction is accelerated.

With the foregoing and other objects in view there is provided, in accordance with the invention, a method for controlling an inking unit of a printing press, in particular an offset printing press, having at least one ink metering element and a control unit. The method comprises changing over the ink metering element from a first ink amount metering, in particular a first size of the opening of the ink metering element, to a second ink amount metering, in particular a second size of the opening of the ink metering element, for a desired inking to be achieved. At least one value of a current actual inking is processed during a non-steady-state phase of the inking unit, with the control unit, for determining a temporary third ink amount metering. The ink metering element is set, with the control unit, to the temporary third ink amount metering at least for a time period during the non-steady-state phase of the inking unit before achieving the desired inking.

The invention makes regulation possible on the basis of a non-steady-state inking. The temporary third ink amount metering is intended to compensate for a signed difference (the amount exceeding or amount undershooting) between the actual ink amount and the desired ink amount in the inking unit. The ink amount in the inking unit is controlled. In particular, the control is suitable for continuous printing. The inking unit can have a plurality of ink metering elements. An ink metering element can, in particular, be an ink blade, an ink slide, a cartridge, a metering eccentric or a metering cylinder.

In accordance with another mode of the invention, the current actual inking is non-steady-state.

The third ink amount metering takes place as a consequence of an increased adjustment of the ink metering element, more precisely an increased adjustment of the size of the opening of the ink metering element. The third ink amount metering can also be called a dynamic ink amount metering.

The current state in the inking unit can differ from measured values which are a measure of the actual inking. In accordance with a further mode of the method according to the invention for controlling an inking unit of a printing press, the value of the current actual inking is therefore a corrected value of a measured non-steady-state actual inking.

In accordance with an added mode of the invention, the corrected value can be a value which is extrapolated into the time evolution of the current actual inking in the future or a predicted value.

In accordance with an additional mode of the invention, the correction takes into consideration the reaction time and/or the dead time of the measuring device and the control unit, in particular the system dead time. The correction can therefore take into consideration the fact that the measurement of the inking of a printing material takes place downstream of the action of the inking unit, while the actuating member, the ink metering element, acts in the inking unit, more accurately acts first of all on the ink distribution in the inking unit. The increased adjustment can therefore take place on the basis of corrected actual values and setpoint values for the inking.

In accordance with yet another mode of the invention, the current actual inking can be determined on the basis of a measurement of the ink layer thickness, a measurement of the spectral reflection or a spectral measurement. A measuring device which is suitable for a specific appropriate measuring process can be linked or connected to the control unit which is used in the method according to the invention. The inking can therefore also be expressed in terms of the density (actual density, desired density for a defined color).

In accordance with yet a further mode of the invention, or as an alternative, the third ink amount metering and the second ink amount metering can differ in the method according to the invention by a signed difference (a setpoint/actual value difference) which is determined as a function of the desired inking that is to be achieved and the current actual inking at the beginning of the time period. In other words, the magnitude of the increased adjustment, more precisely the size and/or the duration of the opening of the ink metering element, are preferably determined as a function of the current actual inking and the desired inking which is to be achieved.

In accordance with yet an added mode of the invention, the method is carried out in an inking unit which has a multiplicity of inking zones in the lateral direction. An inking unit of this type can also be called a zonal inking unit. The method steps which are described in this description or combinations of the method steps are carried out for each ink metering element in each of the inking zones. In this case, the individual ink amount meterings, in particular the third ink amount metering, can be different in magnitude and/or duration (for example, a defined number of copies, reproductions or sheets which are to be printed) during the non-steady-state phase.

In accordance with a concomitant mode of the invention, the printing press, in which the method according to the invention is used, can be a direct or an indirect planographic printing press, in particular an offset printing press. The printing press can, in particular, be a sheet-processing machine. The printing press is preferably a sheet-processing offset printing press. Paper, paperboard, cardboard or organic polymer films can be processed, in particular, as printing materials. The printing press can include a feeder, a multiplicity of printing units, in particular four, six, eight, ten or twelve offset printing units, and a delivery. Moreover, the printing press can also have further units, such as a punching unit or a varnishing unit.

Other features which are considered as characteristic for the invention are set forth in the appended claims.

Although the invention is illustrated and described herein as embodied in a method for controlling an inking unit of a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagram showing inking variables as a function of a time during changeover from a first ink amount metering to a second ink amount metering without temporary increased adjustment of the ink metering element, in an exemplary parameter combination;

FIG. 2 is a diagram showing inking variables as a function of the time during changeover from a first ink amount metering to a second ink amount metering with temporary increased adjustment of the ink metering element according to the prior art for the parameter combination which is shown in FIG. 1; and

FIG. 3 is a diagram showing inking variables as a function of the time during changeover from a first ink amount metering to a second ink amount metering with temporary increased adjustment according to the invention of the ink metering element for the parameter combination which is shown in FIG. 1.

### DESCRIPTION OF THE PREFERRED EMBODIMENTS

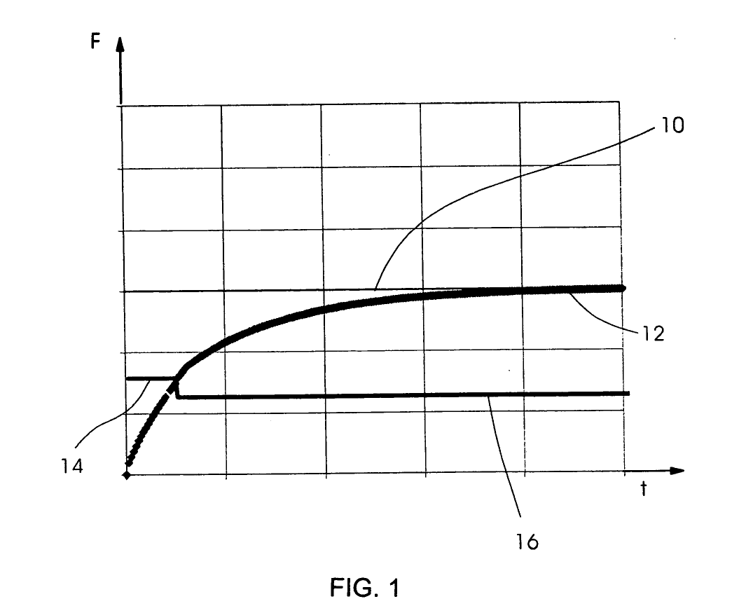

Referring now in detail to the figures of the drawings, in which only inking variables that result from the action of an ink metering element will be considered in order to simplify the illustration without limiting the reference to zonal inking units according to the invention which has already been described, and first, particularly, to FIG. 1 thereof, there is seen an exemplary parameter combination shown in a diagram of inking variables plotted as a function of time during changeover from a first ink amount metering to a second ink amount metering without temporary increased adjustment of the ink metering element. A desired inking 10, a calculated steady-state end value, is to be achieved by the changeover. To this end, an ink metering element is adjusted from a first ink amount metering 14 to a second ink amount metering 16 at a defined instant. A current actual inking 12 has a temporal profile such that it converges monotonously with the desired or setpoint value 10 in a defined reaction time of the inking unit. Sufficient convergence is achieved in this example at approximately three time units.

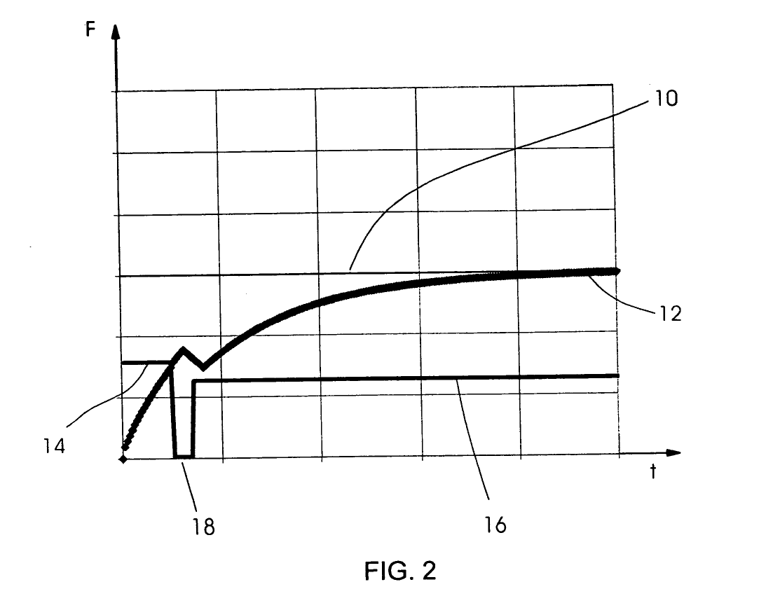

FIG. 2 is a diagram of inking variables as a function of the time during changeover from a first ink amount metering to a second ink amount metering with temporary increased adjustment of the ink metering element according to the prior art for the parameter combination which is shown in FIG. 1. In order to influence the reaction time of the inking unit, a temporary increased adjustment 18 is carried out according to the prior art after the defined instant of the adjustment from the first ink amount metering 14 until another defined instant, at which an adjustment is made to the second ink amount metering 16. According to the prior art, the magnitude and the sign of the temporary adjustment are based on the initial and end values of the ink amount metering and the direction of the change, that is to say in that case a reduction from a greater first ink amount metering 14 to a smaller second ink amount metering 16. In that parameter combination, the temporal profile of the current actual inking 12 experiences a first kink at the defined instant and a second kink at the other defined instant. The temporary increased adjustment 18 according to the prior art is counterproductive in that parameter combination which is shown: the adjustment 18 leads the current actual inking 12 away from the desired inking 10 which is to be achieved, and the current actual inking 12 only converges constantly and monotonously with the desired inking 10 after the adjustment to the second ink amount metering 14 has taken place. Sufficient convergence is achieved in that example only at approximately four time units, that is to say at an instant which is after that without the increased adjustment 18.

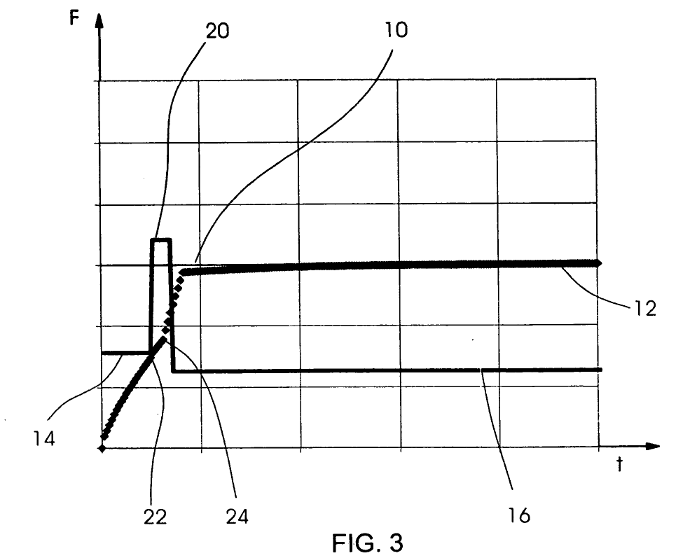

Finally, FIG. 3 shows a diagram of inking variables as a function of the time during changeover from a first ink amount metering 14 to a second ink amount metering 16 with temporary increased adjustment according to the invention of the ink metering element to a third ink amount metering 20 for the parameter combination which is shown in FIG. 1. In order to shorten the reaction time of the inking unit, the temporary third ink amount metering 20 is performed according to the invention after the defined instant of the adjustment from the first ink amount metering 14 until another defined instant, at which an adjustment is made to the second ink amount metering 16. According to the invention, the magnitude and the sign of the temporary adjustment to the third ink amount metering 20 are based on the current actual inking 12 and the desired inking 10. In the case which is shown specifically, the direction of the change to the third ink amount metering 20 is positive, since the current actual inking 12 lies below the desired inking 10 which is to be achieved. However, the basis for the magnitude of this temporary adjustment is not the measured non-steady-state actual inking 22 at the defined instant, but a corrected value 24 which represents a value for the actual inking 12 that is adjusted for the dead time. The corrected value 24 is achieved later as the measured value for the non-steady-state actual inking 12. In this parameter combination, the temporal profile of the current actual inking 12 extends from the instant, at which the corrected value 24 is achieved, toward the desired inking 10 in a steeper monotonous manner and therefore more rapidly. The temporary increased adjustment according to the invention to the third ink amount metering 20 is effectively active in this parameter combination which is shown: the current actual inking 12 converges more rapidly in a continuous and monotonous manner with the desired inking 10. As an advantageous consequence, sufficient convergence is already achieved in this example after approximately three quarters of a time unit, that is to say at an instant which lies considerably before that without increased adjustment 18 and with increased adjustment 18 according to the prior art. While the ink amount meterings are not a good measure of the actual ink amount conditions in the inking unit, an acceleration of the reaction of the inking unit and the convergence of the inking unit setting to a desired inking can be achieved according to the invention on the basis of the current inking 12.

In one advantageous embodiment, according to the invention, the method for setting the inking zone openings is used for continuous printing in an offset printing press having a zonal inking unit and a control computer. The current actual ink layer measured value is detected and fed to the control computer. The current actual ink layer measured value is corrected, and the ink zone opening for the desired layer end value is calculated. An increasing factor as a function of the desired layer end value and the current corrected actual ink layer measured value is calculated. The ink zone openings are loaded with the increasing factor for a defined number of printed sheets.

According to the invention, in one preferred embodiment, the current, non-steady-state actual layer thickness/actual density is used in the calculation of an ink zone adjustment for an increased adjustment. The values are corrected in accordance with the system dead time. In other words, consideration of the system dead time including measured dead time is taken into consideration during the calculation of the dynamic ink zone adjustment. An increased adjustment, on which the overdriving of the ink zone adjustment is based, is calculated from corrected actual and setpoint values. The end value of the ink zone adjustment is based on the ink regulation. The dynamic ink zone adjustment is separate from the calculated static ink zone adjustment.

I claim:

1. A method for controlling an inking unit of a printing press having at least one ink metering element and a control unit, the method comprising the following steps:
changing over the ink metering element from a first ink amount metering to a second ink amount metering for a desired inking to be achieved;
processing at least one value of a current actual inking during a non-steady-state phase of the inking unit, with the control unit, for determining a temporary third ink amount metering; and
setting the ink metering element, with the control unit, to the temporary third ink amount metering at least for a time period during the non-steady-state phase of the inking unit before achieving the desired inking.

2. The method for controlling an inking unit of a printing press according to claim 1, wherein the current actual inking is non-steady-state.

3. The method for controlling an inking unit of a printing press according to claim 1, wherein the at least one value of the current actual inking is a corrected value of a measured non-steady-state actual inking.

4. The method for controlling an inking unit of a printing press according to claim 3, wherein the corrected value is a value extrapolated into a time evolution of the current actual inking in the future.

5. The method for controlling an inking unit of a printing press according to claim 3, wherein the correction takes into consideration at least one of a reaction time or a dead time of the measuring device and the control unit.

6. The method for controlling an inking unit of a printing press according to claim 1, which further comprises determining the current actual inking on a basis of a measurement of an ink layer thickness, a measurement of a spectral reflection or a spectral measurement.

7. The method for controlling an inking unit of a printing press according to claim 1, wherein the third ink amount metering and the second ink amount metering differ by a signed difference determined as a function of the desired inking to be achieved and the current actual inking at a beginning of the time period.

8. The method for controlling an inking unit of a printing press according to claim 1, which further comprises providing the inking unit with a multiplicity of inking zones in a lateral direction, and carrying out the method for the ink measuring element in each of the inking zones.

9. The method for controlling an inking unit of a printing press according to claim 1, wherein the printing press is a sheet-processing offset printing press.
